(19) United States
(12) Patent Application Publication
(10) Pub. No.: US 2020/0067288 A1
(43) Pub. Date: Feb. 27, 2020

(54) Cable Stripping Tool

(71) Applicant: Hanlong Industrial Co., Ltd., New Taipei City 236 (TW)

(72) Inventors: Chien-Chou Liao, New Taipei City (TW); Pai-Wei Lin, New Taipei City (TW)

(21) Appl. No.: 16/242,066

(22) Filed: Jan. 8, 2019

(30) Foreign Application Priority Data
Aug. 21, 2018 (TW) 107211468

(51) Int. Cl. H02G 1/12

(52) U.S. Cl. CPC H02G 1/1217; H02G 1/127; H02G 1/1229

(57) ABSTRACT

A cable stripping tool used for stripping an outer layer of a cable includes a first plier, a second plier, a cable receiving hole, a blade, a first clamping area, and a second clamping area. The second plier is pivotally connected to the first plier by a rotating shaft. The cable receiving hole is disposed on the second plier for receiving the cable. The blade is disposed on the first plier and opposite to the cable receiving hole. The first clamping area and the second clamping area are disposed on the first plier, and the blade is disposed between the first clamping area and the second clamping area; the cable receiving hole, the first clamping area and the second clamping area together clamp the cable such that the blade is able to cut the outer layer of the cable.

### BACKGROUND OF THE INVENTION

### 1. Field of the Invention

The present invention relates to a cable stripping tool; more particularly, the present invention relates to a cable stripping tool that prevents unintentional bending of the cable.

### 2. Description of the Related Art

Generally speaking, the periphery of a signal cable or power cable is coated with at least one outer layer to protect the transmission wire body inside the cable. These outer layers are applied according to different requirements and also correspond to a variety of different cables, such as electrical cables, coaxial cables, optical cables, or the like. When carrying out power dispatch or other operations, the user must strip the outer surface of the cable; therefore, various types of cable stripping tools are available for the user to choose from.

Please refer to FIG. 1, which illustrates a cutaway drawing of the cable stripping tool of the prior art being used for stripping the outer layer of a cable.

The cable stripping tool 90 of the prior art comprises a first plier 91 and a second plier 92. The first plier 91 has a blade 911 and the second plier 92 has a notch 921. When the first plier 91 and the second plier 92 are closed, the first plier 91 and the blade 911 thereof are disposed in the notch 921. When the cable 93 is disposed in the cable stripping tool 90, the first plier 91 and the second plier 92 of the cable stripping tool 90 are rotated and the cable 93 is clamped such that the blade 911 cuts open the outer layer 931 of the cable 93. But if the cable stripping tool 90 is used on a softer or thinner cable 93, the cable 93 can easily be bent by the clamping, as shown in FIG. 1. As a result, the cable stripping tool 90 cannot easily apply force.

Therefore, it is necessary to invent a new cable stripping tool to mitigate and/or obviate the aforementioned problems.

### SUMMARY OF THE INVENTION

It is an object of the present invention to provide a cable stripping tool that does not allow the cable easily to be bent.

To achieve the abovementioned object, the cable stripping tool is used for stripping an outer layer of a cable. The cable stripping tool comprises a first plier, a second plier, a cable receiving hole, a blade, a first clamping area, and a second clamping area. The second plier is pivotally connected to the first plier by a rotating shaft. The cable receiving hole is disposed on the second plier for receiving the cable. The blade is disposed on the first plier and opposite to the cable receiving hole. The first clamping area and the second clamping area are both disposed on the first plier, and the blade is disposed between the first clamping area and the second clamping area. The cable receiving hole, the first clamping area and the second clamping area clamp the cable together such that the blade is able to cut the outer layer of the cable.

### BRIEF DESCRIPTION OF THE DRAWINGS

FIG. 1 illustrates a cutaway drawing of the cable stripping tool of the prior art being used for stripping the outer layer of a cable.

FIG. 2 illustrates an exploded view of a first embodiment of the cable stripping tool of the present invention.

FIG. 3 illustrates a diagram of the first embodiment of the cable stripping tool of the present invention.

FIG. 4 illustrates a side view of the first embodiment of the cable stripping tool of the present invention being used for stripping the outer layer of a cable.

FIG. 4A illustrates a cutaway drawing of the first embodiment of the cable stripping tool of the present invention being used for stripping the outer layer of a cable along the A-A direction of FIG. 4.

FIG. 5 illustrates an actuation drawing of the first embodiment of the cable stripping tool of the present invention being used for stripping the outer layer of a cable.

FIG. 6 illustrates a side view of a second embodiment of the cable stripping tool of the present invention being used for stripping the outer layer of a cable.

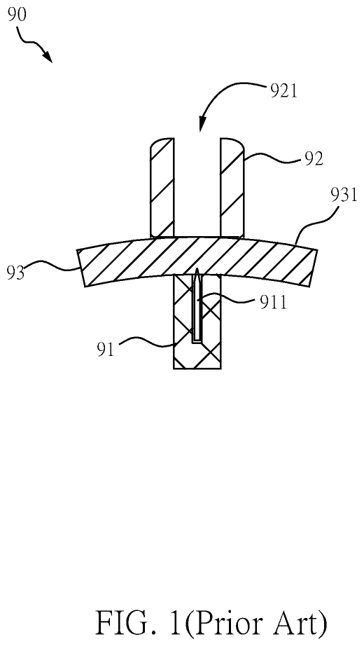

### DETAILED DESCRIPTION OF THE PREFERRED EMBODIMENT

The advantages and innovative features of the invention will become more apparent from the following detailed description when taken in conjunction with the accompanying drawings.

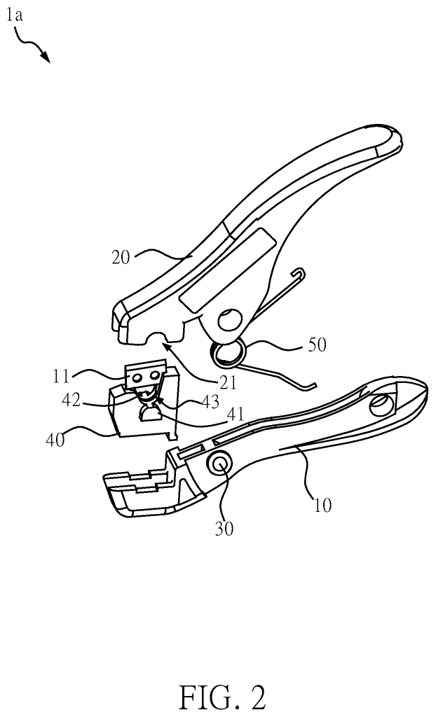

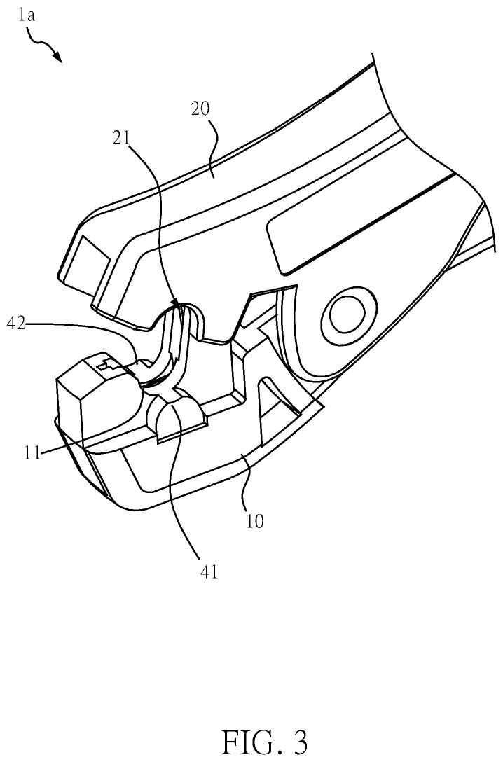

Hereafter, please first refer FIG. 2, which illustrates an exploded view of a first embodiment of the cable stripping tool of the present invention, and FIG. 3, which illustrates a diagram of the first embodiment of the cable stripping tool of the present invention. It should be noted that although the following description uses the terms “first”, “second”, etc. to describe various elements, these elements should not be limited by the terms. These terms are only used to distinguish one element from another. For example, a first plier may be referred to as a second plier; similarly, a second plier may be referred to as a first plier without departing from the scope of the various described embodiments. Each of the first plier and the plier module is a plier, but they are not the same plier.

The cable stripping tool 1a of the present invention is capable of stripping an outer layer 61 of a cable 60. The cable 60 can be an electrical cable, a coaxial cable, an optical cable, and so on, but the present invention is not limited thereto. In a first embodiment of the present invention, the cable stripping tool 1a comprises a first plier 10, a second plier 20, a rotating shaft 30, a first clamping area 41, and a second clamping area 42. The second plier 20 is pivotally connected to the first plier 10 by the rotating shaft 30 such that the first plier 10 is able to rotate with respect to the second plier 20. A cable receiving hole 21 is concave shape and is disposed on the second plier 20 for disposing a cable 60. The blade 11 is disposed on the first plier 10 and opposite to the cable receiving hole 21. An elastic member 50 is further disposed between the first plier 10 and the second plier 20 for providing a clamping force when the first plier 10 and the second plier 20 are rotated to strip the outer layer 61 of a cable 60. The elastic member 50 can also keep the first clamping area 41 and the second clamping area 42 closed.

The first clamping area 41 and the second clamping area 42 are both disposed on the first plier 10, and the blade 11 is disposed between the first clamping area 41 and the second clamping area 42. In the first embodiment of the present invention, the first clamping area 41 and the second clamping area 42 are disposed on a cable placing block 40, and the cable placing block 40 is disposed on the first plier 10. The cable placing block 40 further has a hole 43 which is disposed between the first clamping area 41 and the second clamping area 42 for placement of the blade 11. The blade 11, the first clamping area 41, and the second clamping area 42 are arranged in parallel such that the cable receiving hole 21, the first clamping area 41, and the second clamping area 42 can together clamp a cable 60 such that the blade 11 can cut the outer layer 61 of the cable 60.

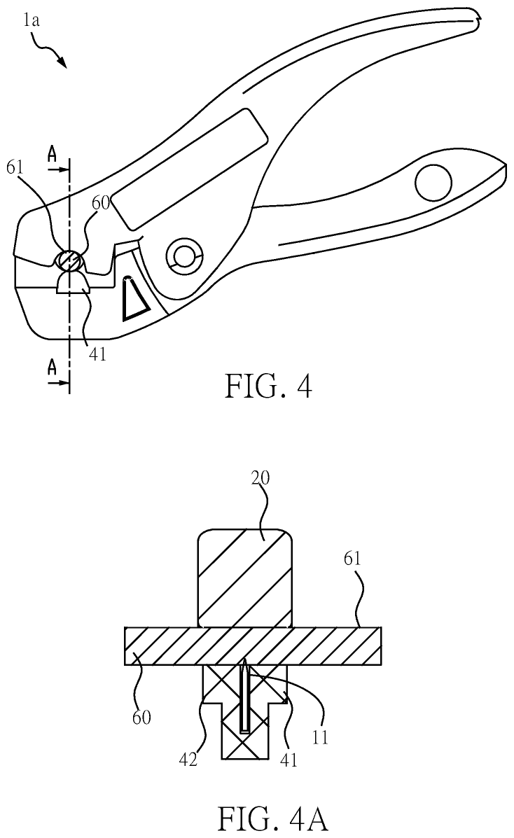

Please refer to FIG. 4, which illustrates a side view of the first embodiment of the cable stripping tool of the present invention being used for stripping the outer layer of a cable, and FIG. 4A illustrates a cutaway drawing of the first embodiment of the cable stripping tool of the present invention being used for stripping the outer layer of a cable along the A-A direction of FIG. 4.

The cable receiving hole 21, the first clamping area 41, and the second clamping area 42 constitute a circular hole together to clamp a cable 60. When the cable receiving hole 21, the first clamping area 41, and the second clamping area 42 are together clamping a cable 60, one part of the cable 60 is kept straight without bending. Thus, the blade 11 is perpendicular to the length of the cable 60.

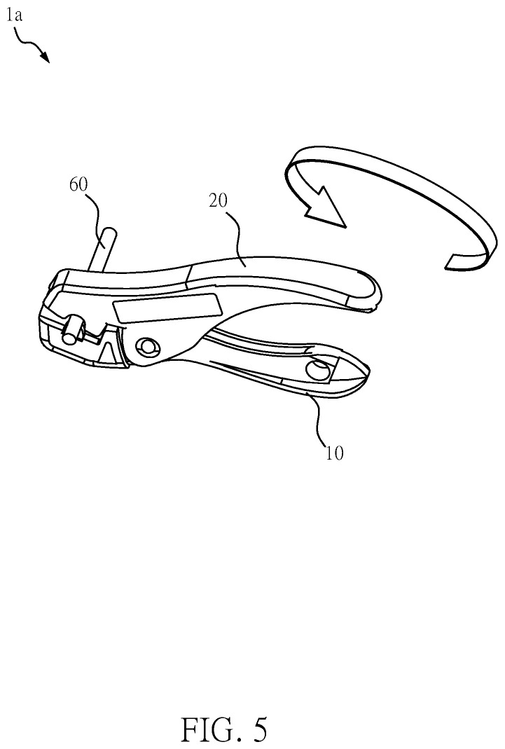

Now please refer to FIG. 5, which illustrates an actuation drawing of the first embodiment of the cable stripping tool of the present invention being used for stripping the outer layer of a cable.

When the outer layer 61 of a cable 60 is stripped, the cable stripping tool 1a can be rotated once as shown in FIG. 5, and the blade 11 will cut the outer layer 61 of the cable 60. Therefore, it is easy for a user to strip the outer layer 61.

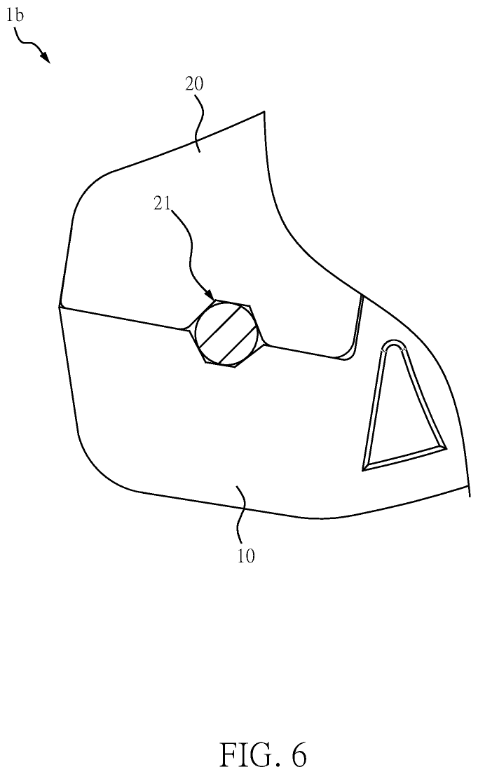

Finally, please refer to FIG. 6, which illustrates a side view of a second embodiment of the cable stripping tool of the present invention being used for stripping the outer layer of a cable.

In the second embodiment of the present invention, a polygonal hole is constituted by the cable receiving hole 21 of the second plier 20 of the cable stripping tool 1b, the first clamping area 41, and the second clamping area 42 of the first plier 10. The outer surface layer 61 of a cable 60 is also stripped off easily due to the polygonal shape.

As a result, bending of the cable 60 can be prevented, and the outer layer 61 of the cable 60 can be stripped off easily by the above-mentioned cable stripping tool 1a or 1b.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A cable stripping tool used for stripping an outer layer of a cable, the cable stripping tool comprising:
a first plier;
a second plier, pivotally connected to the first plier by a rotating shaft; a cable receiving hole, disposed on the second plier for receiving the cable;
a blade, disposed on the first plier and opposite to the cable receiving hole;
a first clamping area, disposed on the first plier; and
a second clamping area, disposed on the first plier, wherein the blade is disposed between the first clamping area and the second clamping area;
the cable receiving hole, the first clamping area and the second clamping area together clamp the cable such that the blade is able to cut the outer layer of the cable.

2. The cable stripping tool as claimed in claim 1, wherein the first clamping area and the second clamping area are disposed on the cable placing block, and the cable placing block further has a hole disposed between the first clamping area and the second clamping area for disposing the blade.

3. The cable stripping tool as claimed in claim 2, wherein the blade, the first clamping area, and the second clamping area are arranged in parallel.

4. The cable stripping tool as claimed in claim 2, wherein the cable receiving hole, the first clamping area, and the second clamping area together form a circular hole.

5. The cable stripping tool as claimed in claim 2, wherein the cable receiving hole, the first clamping area, and the second clamping area together form a polygonal hole.

6. The cable stripping tool as claimed in claim 1, wherein the blade, the first clamping area, and the second clamping area are arranged in parallel.

7. The cable stripping tool as claimed in claim 1, wherein the cable receiving hole, the first clamping area, and the second clamping area together form a circular hole.

8. The cable stripping tool as claimed in claim 1, wherein the cable receiving hole, the first clamping area, and the second clamping area together form a polygonal hole.

9. The cable stripping tool as claimed in claim 1, further comprising an elastic member disposed between the first plier and the second plier for providing a clamping force.
